(19) United States
(12) Patent Application Publication
(10) Pub. No.: US 2016/0241126 A1
(43) Pub. Date: Aug. 18, 2016

(54) CONTINUOUS CURRENT MODE MULTI-LOAD POWER REGULATOR

(71) Applicant: INTEL CORPORATION, Santa-Clara, CA (US)

(72) Inventors: Vaibhav VAIDYA, Portland, OR (US); Krishnan RAVICHANDRAN, Saratoga, CA (US); Nicholas P. COWLEY, Wroughton (GB)

(21) Appl. No.: 15/025,227

(22) PCT Filed: Nov. 27, 2013
(86) PCT No.: PCT/US2013/072329

§ 371 Date: Mar. 25, 2016

(51) Int. Cl. H02M 1/088; H02M 3/07

(52) U.S. Cl. CPC H02M 1/088; H02M 3/07

(57) ABSTRACT

Described is an apparatus which comprises: an interconnect to provide current; a bridge having a high-side switch and a low-side switch, wherein the high-side switch and the low-side switch are coupled to an inductor, and wherein the inductor is coupled to the interconnect; a plurality of switching load stages coupled to the interconnect, wherein each of the switching load stages of the plurality to provide a voltage supply to a load; a first controller to control duty cycle of an input to the bridge to regulate the current provided to the interconnect; and a second controller to control duty cycle of a plurality of inputs, each input to be received by a corresponding switching load stage of the plurality of switching load stages.

### BACKGROUND

Microelectronic circuits in general and digital circuits in particular are designed to be powered from a voltage that needs to be constant during circuit operation, and may be adjusted between periods of circuit operation to maximize efficiency of the circuit. Microprocessor power states are an example of such operation. Power delivery circuits convert power available from a battery or AC (Alternating Current) adapter to an adjustable voltage for the microelectronic circuits while satisfying their static and transient current requirements.

Power delivery to microelectronics is regularly implemented as a cascade of switched voltage regulators. Each stage in the cascade consists of switching power FETs, and passive filter components such as inductors and capacitors. The interface between stages is a voltage rail. For example, in a battery powered cell phone, the varying voltage of the battery is first converted to a constant voltage of, for example, 1.5V or 3.3V, and subsequently converted to the microprocessor voltage range of, for example, 0.4V to 1V by a second stage voltage regulator. A desktop or mobile computer on the other hand may have the first stage voltage regulator convert a high voltage to a low voltage, for example convert 12V to 1.5V, which is then converted to another level, for example 0.4V to 1V range, required by a microprocessor by a second stage voltage regulator. For example, an ‘LC’ voltage regulator (VR) may be used as the first stage board-level regulator and multiple switched-capacitor (SC) voltage regulators may be used as second stage, on-die voltage regulators.

Conversion to a regulated voltage may occur in each cascaded stage at the cost of power loss. In an LCVR for example, the voltage is converted into current variation in an inductor, which is filtered by a capacitor to produce a stable voltage again. Any perturbation in the output voltage is actively absorbed into the inductor and capacitor by the feedback controller, at the cost of power loss. When multiple regulated voltage stages are cascaded, the losses add up, typically leading to a power budget of close to 30% for power delivery alone in modern mobile devices. In addition, the requirement at each stage of a power filter including bulky inductors and capacitors, causes power delivery circuits to consume space which may be constrained in microelectronic applications.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a power regulator with continuous current mode regulation of supply for multiple adjustable loads, according to one embodiment of the disclosure.

FIG. 2 illustrates a secondary controller for regulating of supply to the multiple adjustable loads, according to one embodiment of the disclosure.

FIG. 3 illustrates a circuit for providing inputs to the secondary controller and main controller for regulating the supply to the multiple adjustable loads, according to one embodiment of the disclosure.

FIG. 4 illustrates plots showing closed loop multi-load control for regulating the supply to the multiple adjustable loads, according to one embodiment of the disclosure.

FIGS. 5 illustrates a switching load stage according to one embodiment of the disclosure.

FIGS. 6A-B illustrate switching load stages according to various embodiments of the disclosure.

FIGS. 7-8 illustrate main bridge according to various embodiments of the disclosure.

FIG. 9 illustrates a plot showing inductor switching cycle for various loads, according to one embodiment of the disclosure.

FIG. 10 illustrates a plot showing inductor switching cycle for various loads, according to another embodiment of the disclosure.

FIG. 11 is a smart device or a computer system or an SoC (System-on-Chip) with power regulator with continuous controlled mode regulation of supply for multiple adjustable loads, according to one embodiment of the disclosure.

### DETAILED DESCRIPTION

The embodiments describe a power regulator that draws on the strengths of both LC (inductor-capacitor) and SC (switched-capacitor) VRs (voltage regulators). In the embodiments, a power regulator is described which replaces traditional multi-stage VR approach. In one embodiment, an intermediate current rail is used to replace the output voltage rail of the first traditional VR. There are several technical effects of the embodiments. For example, some embodiments improve efficiency of power supply generation and distribution from 30% to 85% with 10% to 100% load variation.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical connection between the things that are connected, without any intermediary devices. The term “coupled” means either a direct electrical connection between the things that are connected or an indirect connection through one or more passive or active intermediary devices. The term “circuit” means one or more passive and/or active components that are arranged to cooperate with one another to provide a desired function. The term “signal” means at least one current signal, voltage signal or data/clock signal. The meaning of “a,” “an,” and “the” include plural references. The meaning of “in” includes “in” and “on.”

The term “scaling” generally refers to converting a design (schematic and layout) from one process technology to another process technology. The term “scaling” generally also refers to downsizing layout and devices within the same technology node. The terms “substantially,” “close,” “approximately,” “near,” “about,” generally refer to being within +/− 20% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For purposes of the embodiments, the transistors are metal oxide semiconductor (MOS) transistors, which include drain, source, gate, and bulk terminals. The transistors also include Tri-Gate and FinFet transistors. Source and drain terminals may be identical terminals and are interchangeably used herein. Those skilled in the art will appreciate that other transistors, for example, Bi-polar junction transistors BJT PNP/NPN, BiCMOS, CMOS, eFET, etc., may be used without departing from the scope of the disclosure. The term “MN” indicates a n-type transistor (e.g., NMOS, NPN BJT, etc.) and the term “MP” indicates a p-type transistor (e.g., PMOS, PNP BJT, etc.).

The term “power state” or “power mode” generally refers to performance level of the processor or SoC (System-on-Chip). Power states may be defined by Advanced Configuration and Power Interface (ACPI) specification, Revision 5.0, Published Nov. 23, 2011. However, the embodiments are not limited to ACPI power states. Other standards and non-standards defining power state may also be used.

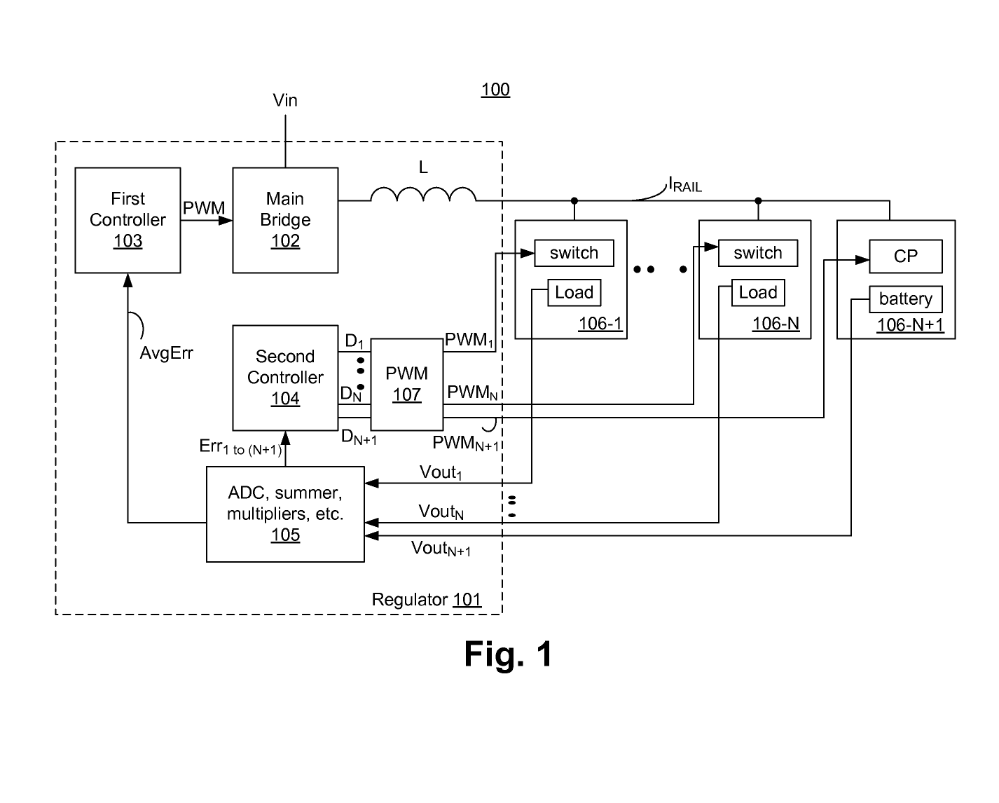

FIG. 1 illustrates a power regulator system 100 with continuous current mode regulation of supply for multiple adjustable loads, according to one embodiment of the disclosure. In one embodiment, power regulator system 100 comprises a power regulator 101 and one or more switching load stages 106-1 to 106-(N+1), where ‘N’ is an integer.

In one embodiment, power regulator 101 includes Inductor ‘L,’ Main Bridge 102, First Controller 103, Second Controller 104, Circuit 105 for providing error signals (Err) to First Controller 103 and Second Controller 104, and PWM 108 (Pulse Width Modulator). In one embodiment, each of the switching load stages 106-1 to 106-N includes a switching transistor and corresponding load which received regulated voltage Vout provided by the switch. In one embodiment, each switch of the switching load stages is controlled by Second Controller 104.

In one embodiment, switching load stages 106-1 to 106-(N+1) include a variety of different switching load stages providing regulated power supply to individual loads. For example, switching load stage 106-(N+1) is a charge pump based voltage regulator while switching load stages 106-1 to 106-N are the same kind of switching load stages but providing regulated voltage and current to different types of loads. In one embodiment, loads in each of the switching load stages can be any logic unit. For example, load can be a processor core, a logic block of a processor core, cache, a stacked memory unit (e.g., stacked by through-silicon-vias), an off-die logic unit, etc.

In the embodiments, power regulator system 100 processes both voltage and current-rails instead of just voltage rails. For example, a first VR loop is used to regulate current provided by inductor L, and a second VR loop(s) are used to regulate voltage for individual switching load stages. In a traditional buck VR, one or more inductors are used to transform the input voltage into a current, and this current is accumulated across its output capacitor to produce a fixed voltage rail for the next stage. Instead of doing this accumulation in the first VR's capacitor, in one embodiment, power regulator 101 (also referred here as a current drive VR) does it in the next stage. In one embodiment, output current of inductor L is directly brought into a second stage (i.e., switch load stage 106-1) and other distributed switching load stages 106-2 to 106-(N+1). In one embodiment, at each switching load stage, a switched-decoupling capacitor converts the current back into any VID (voltage identification) compliant supply voltage required by the power domain.

In one embodiment, First Controller 103 controls duty cycle (D) of the PWM signal (pulse width modulated signal) provided to Main Bridge 102. In one embodiment, Main Bridge 102 receives input power supply Vin and provides current I_{RAIL} to inductor L. In one embodiment, Main Bridge 102 includes a high-side switch and a low-side switch coupled to the inductor. In one embodiment, I_{RAIL} is regulated by a first loop formed by a path comprising I_{RAIL}, Vout₁₋₍ₐᵥ₊₁₎, AvgErr, and PWM. In one embodiment, First Controller 103 includes a Type-3 compensator. In one embodiment, First Controller 103 may also include a pulse width modulator (PWM). In one embodiment, First Controller 103 receives AvgErr signal which indicates an average error in I_{RAIL} relative to a predetermined threshold.

In one embodiment, Second Controller 104 provides D₁-D_{(N+1)} signals which are received by PWM 107 which generates PWM signals PWM₁-PWM_{(N+1)}. In one embodiment, PWM₁ to PWM_{(N+1)} signals control the switching duty cycle of switches in the switching load stages. In one embodiment, Second Controller 104 controls the duty cycle of PWM₁ to PWM_{(N+1)} signals which regulate voltages Vout₁ to Vout_{(N+1)} provided to corresponding loads. In one embodiment, Circuit 105 receives voltages Vout₁ to Vout_{(N+1)} and generates corresponding error signals Err_{1 to (N+1)}. In this embodiment, the second loop(s) is formed by the path comprising Vout₁ to Vout_{(N+1)}, error signals Err_{1 to (N+1)}, and PWM₁ to PWM_{(N+1)} signals. In one embodiment, Second Controller 104 comprises Type-2 compensator(s).

In one embodiment, each error signal of the error signals Err_{1 to (N+1)} indicates a difference between a corresponding voltage level Vout (e.g., one of Vout_{1-(N+1)}) relative to a predetermined voltage level for that load. For example, Err₁ error signal indicates a difference (i.e., error) between Vout₁ (i.e., voltage provided to load) and predetermined voltage level for load corresponding to switching load stage 106-1. In one embodiment, Circuit 105 also generates Average Error signal (AvgErr). In one embodiment, Circuit 105 includes an analog-to-digital converter (ADC), multipliers, adder(s), switching multiplexers, etc.

In one embodiment, switching load stages 106-1 to 106-(N+1) are time-sliced and serviced in a cyclic sequence by power regulator 101. In one embodiment, switching load stages may not be time sliced and can be simultaneously serviced. In one embodiment, output voltages (Vout₁ to Vout_{(N+1)}) and current I_{RAIL} are controlled both by the duty cycle of PWM signal (provided to Main Bridge 102 which provides current to inductor L) and that of PWM₁ to PWM_{(N+1)} signals (provided to the switching load stages 106-1 to 106-(N+1)). In one embodiment, the inductor current I_{RAIL} is the sum of all load currents (of the switching load stages 106-1 to 106-(N+1)), and the duty-cycle of each switching load stage domain is determined by its load current. So as not to obscure the embodiments, the embodiment is explained assuming current through inductor L i.e., I_{RAIL} being constant when the loads switch. In this embodiment, inductor L switches at a lower frequency than the loads. In one embodiment, switching load stages 106-1 to 106-(N+1) may switch much slower depending on the switching frequency of the inductor and the droop requirements of the loads.

Continuing with the example, inductor current I_{RAIL} responds slowly to the voltage across inductor L, and so the supply voltages to the loads are maintained at different voltages Yₒᵤₜ₁, Vₒᵤₜ₂ etc, depending on the required VID for each power domain. Here, each switching load stage of stages 106-1 to 106-(N+1) is identified with a respective power domain In one embodiment, when these loads are duty-cycled, (i.e., switches of the switching load stages 106-1 to 106-(N+1) are provided with their respective duty cycle control signals) the output of the inductor L sees a stepped voltage waveform that switches between the VID compliant supply voltages to all the loads sequentially. Since the inductor current I_{RAIL} is slow to respond, the inductor L effectively sees the average of these VID complaint supply voltage, weighted by duty cycle. Thus the average voltage on the output node of the inductor L in this example is: V_{Irail}=PWM₁·Vₒᵤₜ₁+(1−PWM₁)·Vₒᵤₜ₂, etc., where PWM₂=(1−PWM₁). The duty cycle (D) of PWM signal that drives inductor L is the duty cycle used to maintain V_{Irail} from the input Vᵢₙ: V_{Irail}=D·Vᵢₙ.

Continuing with the example, in one embodiment, the duty cycle of the PWM signal, which controls the current provided to inductor L, is controlled by the input-output voltage ratio. Here, for example, the input voltage is fixed, while the output voltage is determined above as V_{Irail}. In one embodiment, the duty cycles of the signals PWM₁ to PWM_{(N+1)}, which are provided to respective switches, are controlled by the relative currents provided to the loads coupled to the respective switches. In one embodiment, the switches of Main Bridge 102 driving the inductor L are sized to drive all maximum loads of the switching load stages 106-1 to 106-(N+1), whereas individual switch transistors in the switching load stages 106-1 to 106-(N+1) are sized to drive their corresponding loads.

In one embodiment, the major portion of losses in platform regulator system 100 may come from the switched inductor stage i.e., Main Bridge 102 and inductor L. In one embodiment, Main Bridge 102 driving inductor L is 87% efficient with an inductor of Q=25, bringing overall efficiency (power in all the loads to power drawn from Vᵢₙ) to over 85%.

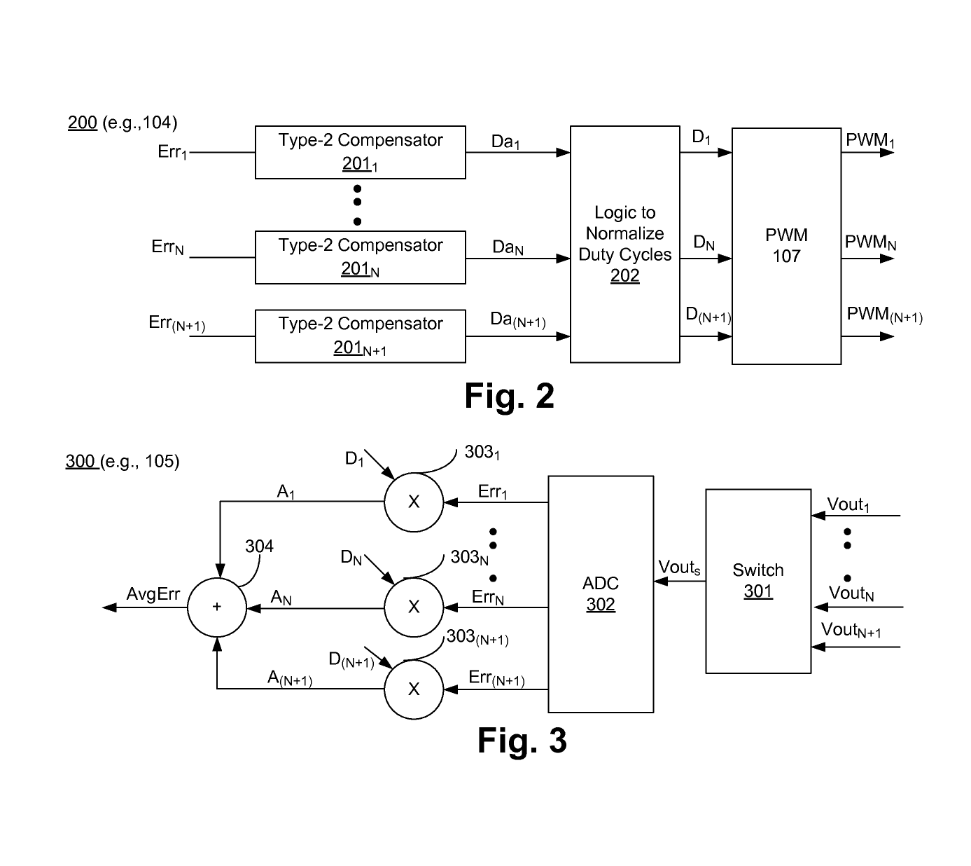

FIG. 2 illustrates a secondary controller 200 (e.g., Second Controller 104) for regulating of supply to the multiple adjustable loads, according to one embodiment of the disclosure. It is pointed out that those elements of FIG. 2 having the same reference numbers (or names) as the elements of any other figure can operate or function in any manner similar to that described, but are not limited to such.

In one embodiment, secondary controller 200 comprises a plurality of Type-2 Compensators 201_{1-(N+1)} and Logic 202 to normalize duty cycles. In other embodiments, other types of compensators may be used for implementing Compensators 201_{1-(N+1)}. In one embodiment, error signals Err_{1-(N+1)} are processed by Compensators 201_{1-(N+1)} to generate duty cycle signals Da_{1-(N+1)}. In one embodiment, each of the Compensators 201_{1-(N+1)} receives an error signal from Circuit 105. For example, Compensator 201₁ receives error signal Err₁ and generates a duty cycle signal Da₁; Compensator 201₂ receives error signal Err₂ and generates a duty cycle signal Da₂, etc.

In one embodiment, Logic 202 normalizes the duty cycle signals Da_{1-(N+1)} to generate duty cycle signals PWM_{1-(N+1)} for the switching load stages 106-1 to 106-(N+1). In one embodiment, Logic 202 normalizes the duty cycle signals Da_{1-(N+1)} such that the sum of duty cycles signals PWM_{1-(N+1)} is one. For example, if N=2 and the compensators calculate the required duty cycles PWM₁₋₃ as 0.5, 0.5, and 0.8, the normalizing logic will change the duty cycle values to 0.5/(0.5+0.5+0.8), 0.5/(0.5+0.5+0.8) and 0.8/(0.5+0.5+0.8) such that they will add up to ‘1’ and can be sequentially time-sliced in a single load PWM cycle.

FIG. 3 illustrates a circuit 300 (e.g., Circuit 105) for providing inputs to the secondary controller and main controller for regulating the supply to the multiple adjustable loads, according to one embodiment of the disclosure. It is pointed out that those elements of FIG. 3 having the same reference numbers (or names) as the elements of any other figure can operate or function in any manner similar to that described, but are not limited to such.

In one embodiment, circuit 300 comprises switch multiplexer 301, ADC 302, multipliers 303_{1-(N+1)}, and adder 304. In one embodiment, switch multiplexer 301 receives voltages Vout_{1-(N+1)} provided to each load of the switching load stages 106-1 to 106-(N+1) and selects one of the received voltages Vout_{1-(N+1)} and provides it as Voutₛ to ADC (Analog to Digital Converter) 302. In one embodiment, switch multiplexer 301 cycles through all the received voltages Vout_{1-(N+1)} one at a time and provides them as Voutₛ to ADC 302. In one embodiment, switching of switch multiplexer 301 is controlled by a clocking signal generated within or outside First or Second Controller (i.e., 103 or 104).

In one embodiment, ADC 302 is a flash ADC. In other embodiments, other types of ADCs may be used to implement ADC 302. In one embodiment, ADC 302 receives an analog voltage Voutₛ and provides a digital representation of Voutₛ, which is an error signal. In one embodiment, as switch multiplexer 301 cycles through all the received voltages Vout_{1-(N+1)} one at a time, ADC 302 provides the corresponding error signal associated with the received voltage. For example, Errₛ corresponds to Vout₁, Err₂ corresponds to Vout₂, etc. In one embodiment, error signals Err_{1-(N+1)} are provided to Second Controller 104.

In one embodiment, the error signals are received by multipliers 303_{1-(N+1)}, each of which multiples an error signal with a corresponding duty cycle signal to generate a product signal A. For example, multiplier 303₁ receives error signal Err₁ and multiplies it with duty cycle signal PWM₁ (which is provided to switching load stage 106-1) and generates a product A₁, multiplier 303₂ receives error signal Err₂ and multiplies it with duty cycle signal PWM₂ (which is provided to switching load stage 106-2) and generates a product A₂, etc. Any multiplier logic may be used to implement multipliers 303_{1-(N+1)}.

In one embodiment, adder 304 receives product signals A_{1-(N+1)} and generates a sum AvgErr (Average Error) of those product signals. In one embodiment, adder 304 is implemented using any known adder architecture. In one embodiment, AvgErr signal is received by First Controller 103.

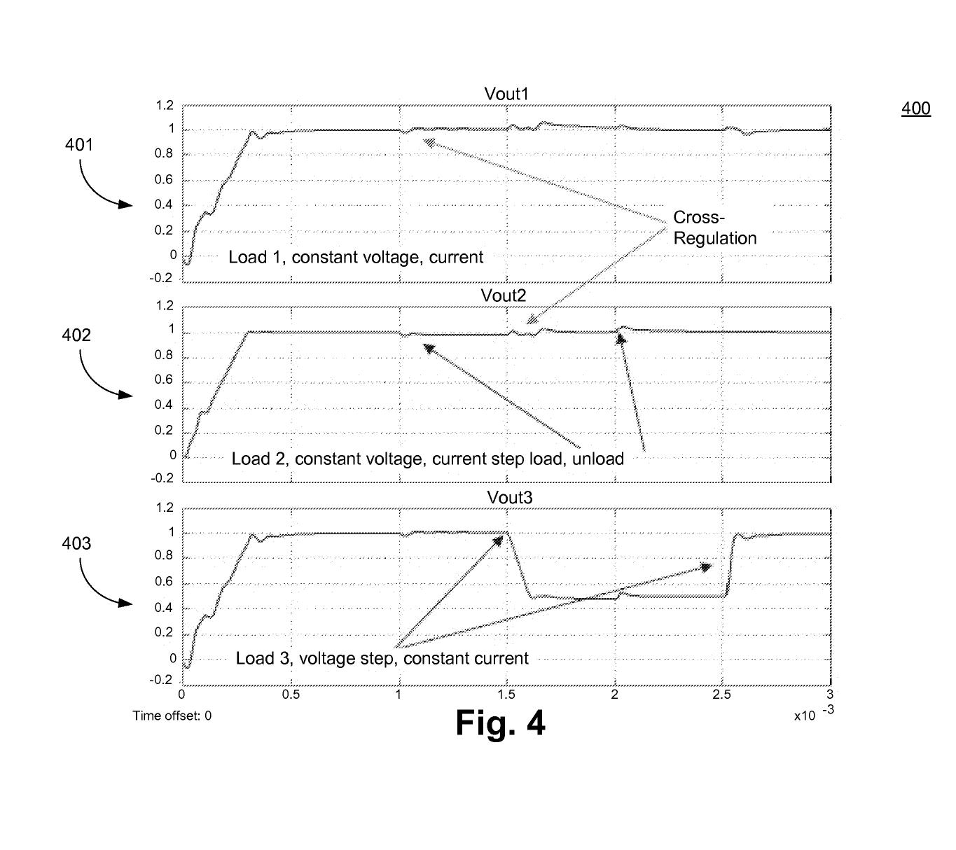

FIG. 4 illustrates plots 400 showing closed loop multi-load control for regulating the supply to the multiple adjustable loads, according to one embodiment of the disclosure. It is pointed out that those elements of FIG. 4 having the same reference numbers (or names) as the elements of any other figure can operate or function in any manner similar to that described, but are not limited to such.

For each plot i.e., plots 401, 402, and 403, x-axis is time and y-axis is voltage. Plots 401, 402, and 403 illustrate cross-regulation performance by power regulator 101. Plot 401 is the transient response for Vout₁. Plot 402 is the transient response for Vout₂. Plot 403 is the transient response for Vout₃. In Plot 403, load of that switching load stage enters into a low power mode and operates on lower power supply voltage of about 0.4V from its normal operating supply level of 1V. Plot 403 shows that each individual switching load stage continues to be regulated in a stable fashion while voltage and load demand changes for different switching load stages.

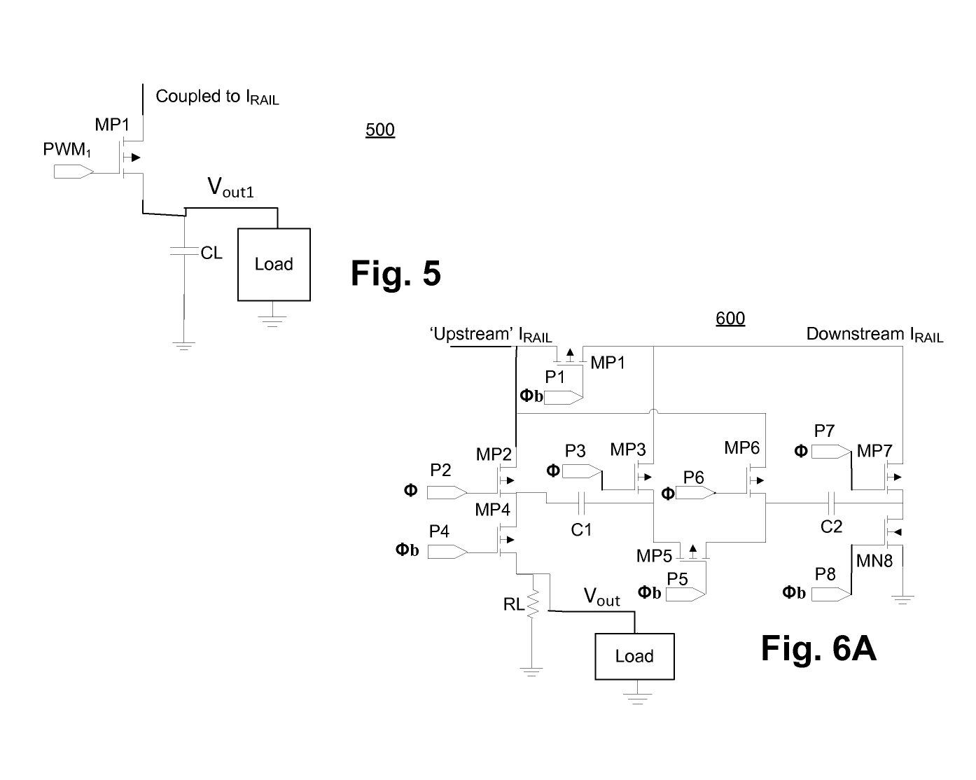

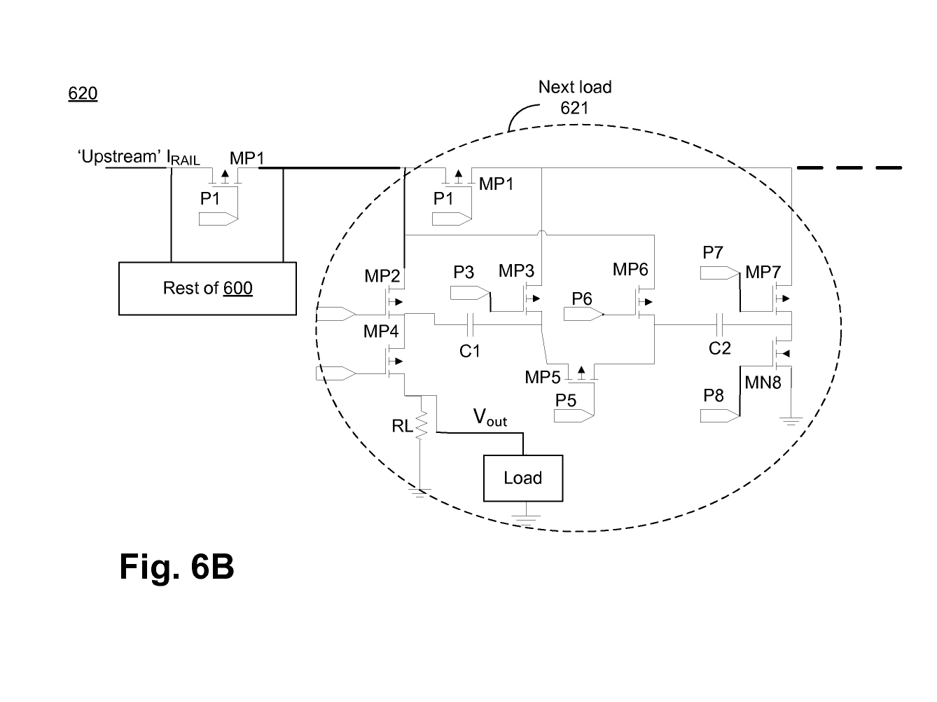

FIGS. 5-6 illustrate switching load stages according to various embodiments of the disclosure. It is pointed out that those elements of FIGS. 5-6 having the same reference numbers (or names) as the elements of any other figure can operate or function in any manner similar to that described, but are not limited to such.

FIG. 5 shows an embodiment of a switching load stage 500 (e.g., 106-1) which includes switch MP1 coupled to a load. In one embodiment, Capacitor CL is part of the load. In one embodiment, switch MP1 is controlled by PWM₁ which has a duty cycle controlled by Second Controller 104. The regulated output voltage Vout₁ is provided to Load and to Circuit 105 for regulation. In this embodiment, source terminal of MP1 is coupled to interconnect carrying I_{RAIL}, and the drain terminal of MP1 is coupled to the Load.

FIG. 6A shows an embodiment of a switching load stage 600 (e.g., 106-(N+1) which includes a charge-pump coupled to a load. In one embodiment, charge-pump includes p-type transistors MP1, MP2, MP3, MP4, MPS, MP6, and MP7, n-type transistor MN8, and capacitors C1 and C2. In one embodiment, MP1 is coupled to interconnect providing I_{RAIL}. In one embodiment, gate terminal of MP1 is controlled by P1, gate terminal of MP2 is controlled by P2, gate terminal of MP3 is controlled by P3, gate terminal of MP4 is controlled by P4, gate terminal of MP5 is controlled by P5, gate terminal of MP6 is controlled by P6, gate terminal of MP7 is controlled by P7, and gate terminal of MN8 is controlled by P8. In one embodiment, current rail is on both sides of switch MP1. For example, one side (drain/source) of MP1 is coupled to Upstream I_{RAIL} and the other side (drain/source) of MP1 is coupled to Downstream I_{RAIL}. Unlike voltage rails, current flows through circuits in series.

In one embodiment, capacitor C1 is coupled to the drain terminal of MP2 and source terminal of MP4 at one end and coupled to drain terminal of MP3 and source terminal of MP5 at the other end. In one embodiment, capacitor C2 is coupled to the drain terminal of MP6 and source terminal of MP5 at one end and coupled to drain terminal of MP7 and drain terminal of MN8 at the other end. A person skilled in the art knows that the source and drain terminals are identical terminals and may switch labels according to voltages applied on them. In one embodiment, drain terminal of MP4 is coupled to the Load. In one embodiment, resistor RL is part of the load. The regulated supply provided to Load is Vout (e.g., Vout_{(N+1)}).

In one embodiment, the charge pump of FIG. 6A is 1:2 boost charge pump. In one embodiment, the charge pump can be replaced by a higher ratio than 1:2. The operation of the charge pump is two-phased, indicated by 1 and Φb, where Φb is an inverse of Φ. In one embodiment, switches that are ON in phase Φ are OFF in phase Φ, and vice versa. In one embodiment, in phase D, inputs P2, P3, P6, and P7 turn their respective FETs ON, bringing C1 and C2 in parallel across the transistor MP1, which is OFF. In one embodiment, the capacitors charge through the incoming current from the current rail, which continues downstream to other loads. In one embodiment, in phase Φb, inputs P1, P4, P5, and P8 turn their respective FETs ON, bringing C1 and C2 in series across the load, and provide current continuity on the current rail by turning MP1 ON. In such an embodiment, the load sees double the voltage that the current rail charges C1, C2 to. For example, if the load were a memory chip, it could be maintained at a higher voltage than the main current rail which could reside on the CPU chip and be connected through TSVs (through-silicon vias) to the memory chip. The charge pump of the embodiment has high efficiency across all voltages, since it is charged from a current rail.

FIG. 6B shows an embodiment of multiple switching load stages 620 some of which include a charge-pump coupled to a load. It is pointed out that those elements of FIG. 6B having the same reference numbers (or names) as the elements of any other figure can operate or function in any manner similar to that described, but are not limited to such.

In one embodiment, multiple switching load stages 620 includes a first stage 621 (same as 600 of FIG. 6A) and second stage 622. In this embodiment, second stage 622 is identical to first stage 621 in circuit topology and function. In one embodiment, what phase second stage 621 is in (Φ or Φb) is independent of first stage as long as any voltage limits for maximum electrical ratings and for the step-down function of the switched inductor stage are not exceeded. In one embodiment, if said voltage limits are being approached, then second stage 622 (and other following stages) operates in Ob when first stage 621 operates in Φ.

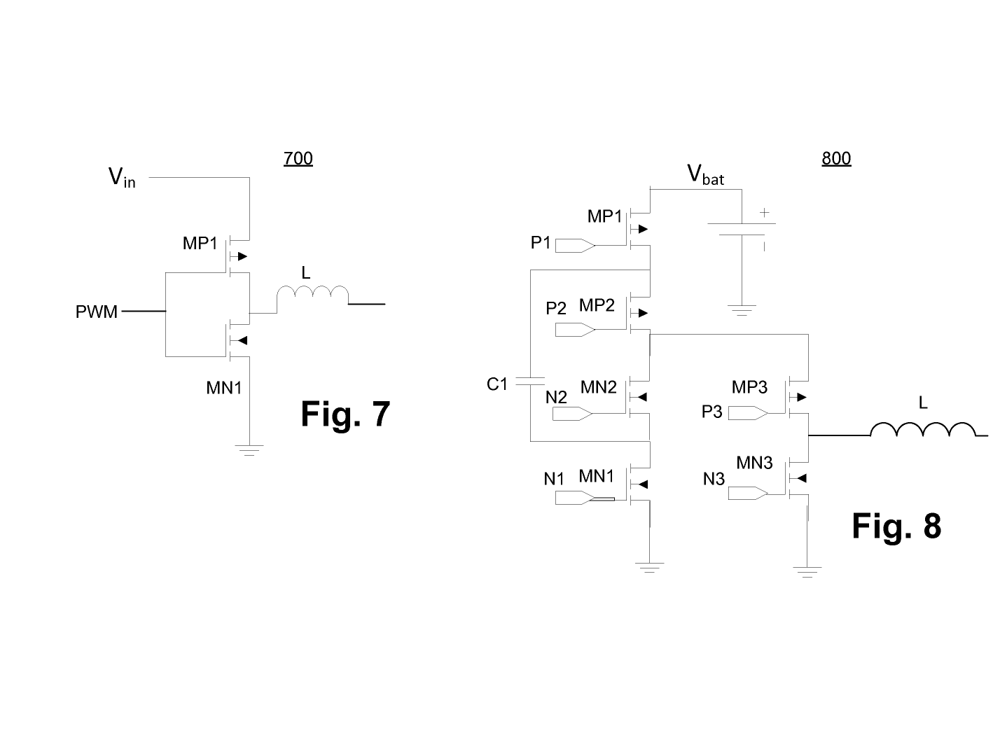

FIGS. 7-8 illustrate main bridges according to various embodiments of the disclosure. It is pointed out that those elements of FIGS. 7-8 having the same reference numbers (or names) as the elements of any other figure can operate or function in any manner similar to that described, but are not limited to such.

FIG. 7 illustrates a main bridge 700 (e.g., Main Bridge 102) having a high-side switch MP1 and a low-side switch MN1 coupled together in series, according to one embodiment. In this embodiment, source terminal of MP1 is coupled to input power supply Vin, drain terminal of MP1 is coupled to drain terminal of MN1 which is also coupled to inductor L. In one embodiment, output DC of First Controller 103 regulates the current I_{RAIL} through inductor L.

FIG. 8 illustrates switched capacitor based main bridge 800 (e.g., Main Bridge 102), according to one embodiment. In this embodiment, input power supply is provided by a battery source Vbat, but is not limited to such. In one embodiment, Main Bridge 800 comprises p-type transistors MP1, MP2, and MP3, and n-type transistors MN1, MN2, and MN3. In one embodiment, gate terminal of MP1 is controlled by P1, gate terminal of MP2 is controlled by P2, gate terminal of MP2 is controlled by P3, gate terminal of MN1 is controlled by N1, gate terminal of MN2 is controlled by N2, gate terminal of MN3 is controlled by N3. In one embodiment, a step down function is performed by MP3 and MN3 which are coupled to inductor L. In one embodiment, a capacitor C1 (also referred to as a flying capacitor) is coupled to the drain terminal of MP1 and drain terminal of MN1.

In one embodiment, either MP1 or MN2 are turned on together, charging C1 through the current draw of MP3, or MP2 and MN1 are turned on together, discharging C1 through the same current draw. In one embodiment, when C1 is charging, the supply to MP3 is equal to Vbat voltage across C1, where as when C1 is discharging, the supply of MP3 is equal to the voltage across C1. In one embodiment, if the time for which C1 is charging and discharging is equal, C1 can be maintained at half of Vbat (i.e., battery voltage), such that the supply to MP3 is maintained at half of Vbat. This is possible as the input of MP3 is a current input for the switched inductor stage, and the energy transfer between these stages thus occurs at high efficiency irrespective of current. In one embodiment, the frequency of switching for MP1, MP2, MN1, and MN2 may be determined by a common controller depending on the current drawn by inductor L.

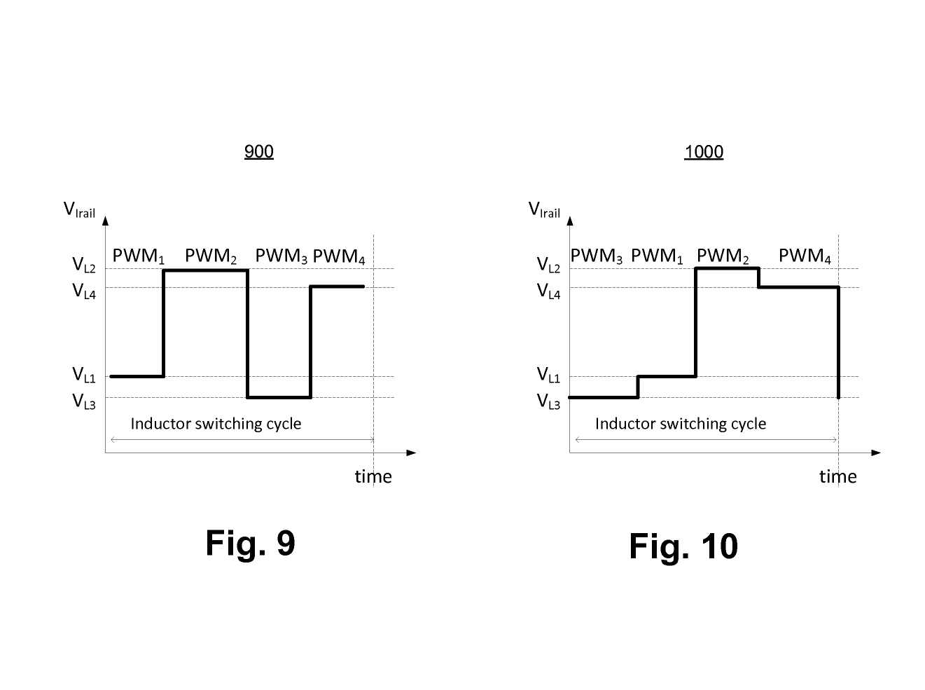

FIG. 9 illustrates a plot 900 showing inductor switching cycle for various loads, according to one embodiment of the disclosure. It is pointed out that those elements of FIG. 9 having the same reference numbers (or names) as the elements of any other figure can operate or function in any manner similar to that described, but are not limited to such.

When a current rail supplies a switching load stage, the dead-time between the “on” and “off” switches on a current rail during commutation of loads may cause the current through the load switches to be discontinuous. The current flowing through the current rail then charges up the parasitic capacitance on the current rail, causing a potential voltage overshoot that can damage switching transistors on the current rail. To prevent damage, in one embodiment, the dead time is made small enough for the voltage on the current rail to stay within safe limits. In one embodiment, with higher parasitic capacitance of the current rail, more dead-time can be afforded.

The voltage overshoot ΔV_{current rail} on the current rail during commutation of loads can be calculated using:

(dV/dt)_{current rail}=(I_{density, load})/(C_{density, current rail})

ΔV_{current rail}=(dV/dt)_{current rail}X t_{commutation deadtime}

Using typical values for a 32 nm processor, the voltage overshoot can be within 50 mV for only 1% parasitic loss on the current rail, for example.

When a current rail supplies many loads as in FIG. 1, the voltage on the current rail cycles between the voltages of all the loads of the switching load stages. The parasitic capacitance on the current rail thus gets charged and discharged, causing energy loss. Higher the parasitic capacitance, higher the loss. One such pattern of cycling of voltages to various loads during a period of PWM signal is illustrated in plot 900 of FIG. 9.

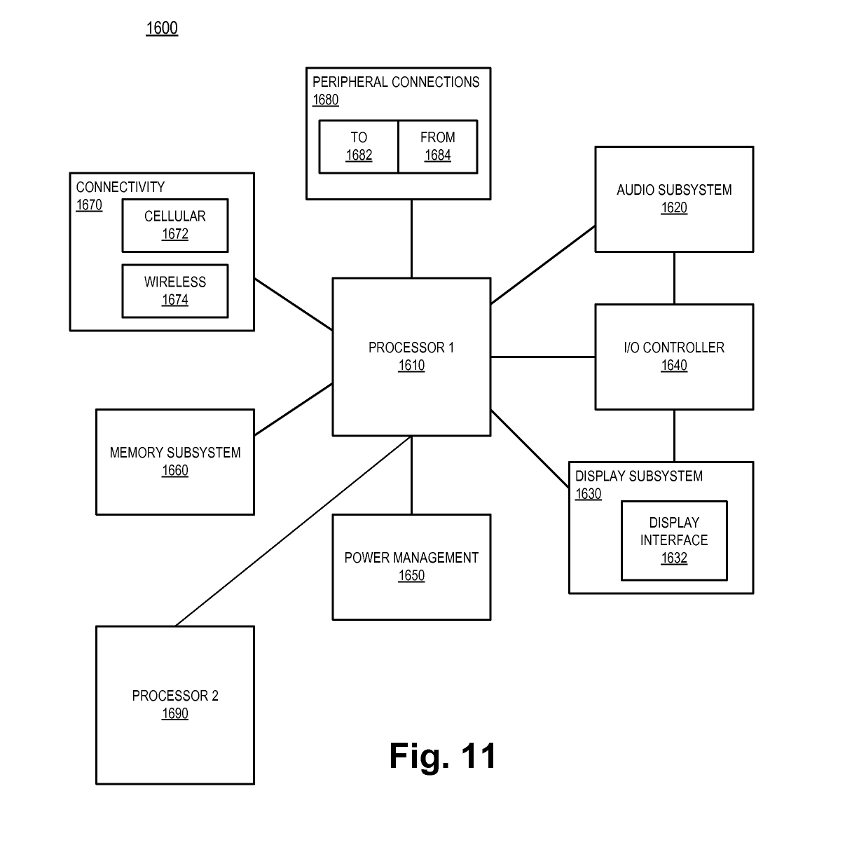

Here, x-axis is time and y-axis is voltage. Here, V_{L1} is same as Vₒᵤₜ₁, V_{L2} is same as Vₒᵤₜ₂, V_{L3} is same as Vₒᵤₜ₃, and V_{L4} is same as Vₒᵤₜ₄. In one period of PWM signal (i.e., one inductor switching cycle), energy loss is observed when cycling from switching load stage 106-1 to 106-2 to 106-3 and then from 106-3 to 106-4 and back to 106-1 in the next DC cycle, because Vₒᵤₜ₁ is lower than Vₒᵤₜ₂, Vₒᵤₜ₂ is higher than Vₒᵤₜ₃, Vₒᵤₜ₃ is lower than Vₒᵤₜ₄, and Vₒᵤₜ₄ is higher than Vₒᵤₜ₁ again causing the voltage on the current rail to rise and fall many times during a single PWM cycle. In one embodiment, this energy loss is mitigated by changing the order of voltages from lowest to highest, so that the rail only charges and discharges once in an inductor switching cycle as shown in FIG. 10.

FIG. 10 illustrates a plot 1000 showing inductor switching cycle for various loads, according to another embodiment of the disclosure. It is pointed out that those elements of FIG. 10 having the same reference numbers (or names) as the elements of any other figure can operate or function in any manner similar to that described, but are not limited to such.

Here, x-axis is time and y-axis is voltage. In one embodiment, First Controller 103 changes the phases of PWM signal such that in one PWM cycle, minimum energy loss is observed because voltage supplied to respective loads increases and decreases once in one PWM cycle. In this example, Vₒᵤₜ₃ is lower than Vₒᵤₜ₁, and Vₒᵤₜ₁ is lower than Vₒᵤₜ₂. In this example a smaller energy loss is shown between Vₒᵤₜ₃ and Vₒᵤₜ₄.

FIG. 11 is a smart device or a computer system or an SoC (System-on-Chip) 1600 with power regulator with continuous controlled mode regulation of supply for multiple adjustable loads, according to one embodiment of the disclosure. It is pointed out that those elements of FIG. 11 having the same reference numbers (or names) as the elements of any other figure can operate or function in any manner similar to that described, but are not limited to such.

FIG. 11 illustrates a block diagram of an embodiment of a mobile device in which flat surface interface connectors could be used. In one embodiment, computing device 1600 represents a mobile computing device, such as a computing tablet, a mobile phone or smart-phone, a wireless-enabled e-reader, or other wireless mobile device. It will be understood that certain components are shown generally, and not all components of such a device are shown in computing device 1600.

In one embodiment, computing device 1600 includes a first processor 1610 with power regulator with continuous controlled mode regulation of supply for multiple adjustable loads according to the embodiments. In one embodiment, computing device 1600 includes a second processor 1690 with power regulator with continuous controlled mode regulation of supply for multiple adjustable loads, according to the embodiments discussed herein. In one embodiment, second processor 1690 is optional. Other blocks of the computing device 1600 with I/O drivers may also include power regulator with continuous controlled mode regulation of supply for multiple adjustable loads of the embodiments. The various embodiments of the present disclosure may also comprise a network interface within 1670 such as a wireless interface so that a system embodiment may be incorporated into a wireless device, for example, cell phone or personal digital assistant.

In one embodiment, processor 1610 can include one or more physical devices, such as microprocessors, application processors, microcontrollers, programmable logic devices, or other processing means. The processing operations performed by processor 1610 include the execution of an operating platform or operating system on which applications and/or device functions are executed. The processing operations include operations related to I/O (input/output) with a human user or with other devices, operations related to power management, and/or operations related to connecting the computing device 1600 to another device. The processing operations may also include operations related to audio I/O and/or display I/O.

In one embodiment, computing device 1600 includes audio subsystem 1620, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 1600, or connected to the computing device 1600. In one embodiment, a user interacts with the computing device 1600 by providing audio commands that are received and processed by processor 1610.

Display subsystem 1630 represents hardware (e.g., display devices) and software (e.g., drivers) components that provide a visual and/or tactile display for a user to interact with the computing device 1600. Display subsystem 1630 includes display interface 1632, which includes the particular screen or hardware device used to provide a display to a user. In one embodiment, display interface 1632 includes logic separate from processor 1610 to perform at least some processing related to the display. In one embodiment, display subsystem 1630 includes a touch screen (or touch pad) device that provides both output and input to a user.

I/O controller 1640 represents hardware devices and software components related to interaction with a user. I/O controller 1640 is operable to manage hardware that is part of audio subsystem 1620 and/or display subsystem 1630. Additionally, I/O controller 1640 illustrates a connection point for additional devices that connect to computing device 1600 through which a user might interact with the system. For example, devices that can be attached to the computing device 1600 might include microphone devices, speaker or stereo systems, video systems or other display devices, keyboard or keypad devices, or other I/O devices for use with specific applications such as card readers or other devices.

As mentioned above, I/O controller 1640 can interact with audio subsystem 1620 and/or display subsystem 1630. For example, input through a microphone or other audio device can provide input or commands for one or more applications or functions of the computing device 1600. Additionally, audio output can be provided instead of, or in addition to display output. In another example, if display subsystem 1630 includes a touch screen, the display device also acts as an input device, which can be at least partially managed by I/O controller 1640. There can also be additional buttons or switches on the computing device 1600 to provide I/O functions managed by I/O controller 1640.

In one embodiment, I/O controller 1640 manages devices such as accelerometers, cameras, light sensors or other environmental sensors, or other hardware that can be included in the computing device 1600. The input can be part of direct user interaction, as well as providing environmental input to the system to influence its operations (such as filtering for noise, adjusting displays for brightness detection, applying a flash for a camera, or other features).

In one embodiment, computing device 1600 includes power management 1650 that manages battery power usage, charging of the battery, and features related to power saving operation. Memory subsystem 1660 includes memory devices for storing information in computing device 1600. Memory can include nonvolatile (state does not change if power to the memory device is interrupted) and/or volatile (state is indeterminate if power to the memory device is interrupted) memory devices. Memory subsystem 1660 can store application data, user data, music, photos, documents, or other data, as well as system data (whether long-term or temporary) related to the execution of the applications and functions of the computing device 1600.

Elements of embodiments are also provided as a machine-readable medium (e.g., memory 1660) for storing the computer-executable instructions (e.g., instructions to implement any other processes discussed herein). The machine-readable medium (e.g., memory 1660) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 1670 includes hardware devices (e.g., wireless and/or wired connectors and communication hardware) and software components (e.g., drivers, protocol stacks) to enable the computing device 1600 to communicate with external devices. The computing device 1600 could be separate devices, such as other computing devices, wireless access points or base stations, as well as peripherals such as headsets, printers, or other devices.

Connectivity 1670 can include multiple different types of connectivity. To generalize, the computing device 1600 is illustrated with cellular connectivity 1672 and wireless connectivity 1674. Cellular connectivity 1672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 1674 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 1680 include hardware interfaces and connectors, as well as software components (e.g., drivers, protocol stacks) to make peripheral connections. It will be understood that the computing device 1600 could both be a peripheral device (“to” 1682) to other computing devices, as well as have peripheral devices (“from” 1684) connected to it. The computing device 1600 commonly has a “docking” connector to connect to other computing devices for purposes such as managing (e.g., downloading and/or uploading, changing, synchronizing) content on computing device 1600. Additionally, a docking connector can allow computing device 1600 to connect to certain peripherals that allow the computing device 1600 to control content output, for example, to audiovisual or other systems.

In addition to a proprietary docking connector or other proprietary connection hardware, the computing device 1600 can make peripheral connections 1680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, in one embodiment an apparatus is provided which comprises: an interconnect to provide current; a bridge having a high-side switch and a low-side switch, wherein the high-side switch and the low-side switch are coupled to an inductor, and wherein the inductor is coupled to the interconnect; a plurality of switching load stages coupled to the interconnect, wherein each of the switching load stages of the plurality to provide a voltage supply to a load; a first controller to control duty cycle of an input to the bridge to regulate the current provided to the interconnect; and a second controller to control duty cycle of a plurality of inputs, each input to be received by a corresponding switching load stage of the plurality of switching load stages.

In one embodiment, the second controller comprises a plurality of type-2 compensators. In one embodiment, the second controller comprises a logic unit to normalize duty cycle of the plurality of inputs such that the sum of duty cycles for all the plurality of inputs is one. In one embodiment, each of the type-2 compensators of the plurality of type-2 compensators is coupled to the logic unit. In one embodiment, the apparatus further comprises an analog-to-digital converter (ADC) which is operable to receive sampled voltage from each of the switching load stages of the plurality, the sampled voltage associated with voltage provided to a load of a switching load stage.

In one embodiment, the ADC provides a plurality of error signals, each of which is associated with a corresponding sampled voltage associated with the voltage provided to the load of the switching load stage from the plurality of switching load stages. In one embodiment, the ADC is coupled to the plurality of type-2 compensators such that the plurality of error signals is received by the plurality of type-2 compensators. In one embodiment, the apparatus further comprises: a plurality of multipliers, each of which to multiply an error signal from the plurality of error signals with an output of the logic unit; and an adder to add outputs of each of the plurality of multipliers to generate an average error for input to the first controller. In one embodiment, the first controller comprises a type-3 compensator.

In another example, an apparatus is provided which comprises: a bridge having a high-side switch and a low-side switch, wherein the high-side switch and the low-side switch are coupled to an inductor, and wherein the inductor is coupled to an interconnect which provides a regulated current; and a plurality of switching load stages coupled to the interconnect, wherein each of the switching load stages of the plurality to provide a voltage supply to a load, wherein the bridge to switch at a frequency which is different from a switching frequency associated with each of the switching load stages of the plurality.

In one embodiment, the apparatus further comprises: a first controller to control duty cycle of an input to the bridge to regulate the current provided to the interconnect. In one embodiment, the first controller comprises a type-3 compensator. In one embodiment, the apparatus further comprises: a second controller to control duty cycle of a plurality of inputs, each input to be received by a corresponding switching load stage of the plurality of switching load stages. In one embodiment, the second controller comprises a plurality of type-2 compensators. In one embodiment, the second controller comprises a logic unit to normalize duty cycle of the plurality of inputs such that the sum of duty cycles for all the plurality of inputs is one.

In one embodiment, at least one of the switching load stages includes a p-type transistor coupled to the interconnect and a load, and wherein the p-type transistor is controllable by a signal provided by the second controller. In one embodiment, at least one of the switching load stages includes a charge pump.

In another example, a system is provided which comprises: a memory unit; a processor, coupled to the memory unit by through-silicon-vias (TSVs), the processor having a power regulator according to various embodiments of the apparatus; and a wireless interface for allowing the processor to communicate with another device. In one embodiment, one of the loads associated with the plurality of switching load stages is the memory unit. In one embodiment, the system further comprises a display unit. In one embodiment, the display unit is a touch screen.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
an interconnect to provide current;
a bridge having a high-side switch and a low-side switch, wherein the high-side switch and the low-side switch are coupled to an inductor, and wherein the inductor is coupled to the interconnect;
a plurality of switching load stages coupled to the interconnect, wherein each of the switching load stages of the plurality to provide a voltage supply to a load;
a first controller to control duty cycle of an input to the bridge to regulate the current provided to the interconnect; and
a second controller to control duty cycle of a plurality of inputs, each input to be received by a corresponding switching load stage of the plurality of switching load stages.

2. The apparatus of claim 1, wherein the second controller comprises a plurality of type-2 compensators.

3. The apparatus of claim 2, wherein the second controller comprises a logic unit to normalize duty cycle of the plurality of inputs such that the sum of duty cycles for all the plurality of inputs is one.

4. The apparatus of claim 3, wherein each of the type-2 compensators of the plurality of type-2 compensators is coupled to the logic unit.

5. The apparatus of claim 4 further comprises an analog-to-digital converter (ADC) which is operable to receive sampled voltage from each of the switching load stages of the plurality, the sampled voltage associated with voltage provided to a load of a switching load stage.

6. The apparatus of claim 5, wherein the ADC to provide a plurality of error signals, each of which is associated with a corresponding sampled voltage associated with the voltage provided to the load of the switching load stage from the plurality of switching load stages.

7. The apparatus of claim 6, wherein the ADC is coupled to the plurality of type-2 compensators such that the plurality of error signals is received by the plurality of type-2 compensators.

8. The apparatus of claim 6 further comprises:
a plurality of multipliers, each of which to multiply an error signal from the plurality of error signals with an output of the logic unit; and
an adder to add outputs of each of the plurality of multipliers to generate an average error for input to the first controller.

9. The apparatus of claim 1, wherein the first controller comprises a type-3 compensator.

10. A system comprising:
a memory unit;
a processor, coupled to the memory unit by through-silicon-vias (TSVs), the processor having a power regulator according to any one of apparatus claims 1 to 9; and
a wireless interface for allowing the processor to communicate with another device.

11. The system of claim 10, wherein one of the loads associated with the plurality of switching load stages is the memory unit.

12. The system of claim 10 further comprises a display unit.

13. An apparatus comprising:
a bridge having a high-side switch and a low-side switch, wherein the high-side switch and the low-side switch are coupled to an inductor, and wherein the inductor is coupled to an interconnect which provides a regulated current; and
a plurality of switching load stages coupled to the interconnect, wherein each of the switching load stages of the plurality to provide a voltage supply to a load,
wherein the bridge to switch at a frequency which is different from a switching frequency associated with each of the switching load stages of the plurality.

14. The apparatus of claim 13 further comprises:
a first controller to control duty cycle of an input to the bridge to regulate the current provided to the interconnect.

15. The apparatus of claim 14, wherein the first controller comprises a type-3 compensator.

16. The apparatus of claim 14 further comprises:
a second controller to control duty cycle of a plurality of inputs, each input to be received by a corresponding switching load stage of the plurality of switching load stages.

17. The apparatus of claim 16, wherein the second controller comprises a plurality of type-2 compensators.

18. The apparatus of claim 17, wherein the second controller comprises a logic unit to normalize duty cycle of the plurality of inputs such that the sum of duty cycles for all the plurality of inputs is one.

19. The apparatus of claim 13, wherein at least one of the switching load stage includes a p-type transistor coupled to the interconnect and a load, and wherein the p-type transistor is controllable by a signal provided by the second controller.

20. The apparatus of claim 13, wherein at least one of the switching load stages includes a charge pump.

21. A system comprising:
a memory unit;
a processor, coupled to the memory unit by through-silicon-vias (TSVs), the processor having a power regulator according to any one of apparatus claims 13 to 20; and
a wireless interface for allowing the processor to communicate with another device.

22. The system of claim 21 further comprises a display unit.
